(19) United States
(12) Patent Application Publication
(10) Pub. No.: US 2009/0057526 A1
(43) Pub. Date: Mar. 5, 2009

(54) Loudspeaker Stabilizer

(76) Inventor: Peter Janis, Port Coquitlam (CA)

Correspondence Address: MCNEELY BODENDORF LLP, P.O. BOX 34175, WASHINGTON, DC, 20043, US

(21) Appl. No.: 11/949,352

(22) Filed: Dec. 3, 2007

Related U.S. Application Data
(60) Provisional application No. 60/968,868, filed on Aug. 29, 2007.

(51) Int. Cl. F16M 11/20

(52) U.S. Cl. 248/638

(57) ABSTRACT

An apparatus for stabilizing a speaker with respect to a surface includes an isolation portion to isolate the speaker from the surface and a stabilizing portion provided between the speaker and the isolation portion to stabilize the speaker.

### CROSS-REFERENCE TO RELATED APPLICATION

This application claims the benefit under 35 U.S.C. § 119(e)(1) of a U.S. provisional patent application No. 60/968,868, filed on Aug. 29, 2007 in the United States Patent and Trademark Office, the entire disclosure of which is hereby incorporated by reference.

### TECHNICAL FIELD

The following description relates to a loudspeaker stabilizing system. More particularly, the description relates to an apparatus, system and/or method for stabilizing a loudspeaker.

### BACKGROUND

Recording studio engineers and audio enthusiasts have been trying to achieve the high quality sound reproduction by seeking out the very best loudspeakers to suit their musical preferences. In an illustrative case of a studio engineer, once a speaker has been selected, the engineer will typically bring his speaker to various studios in effort to provide a ‘starting point’ for consistent and repeatable sound reproduction. Uncontrollable factors such as room acoustics and speaker placement may be minimized by using near field monitors. These are generally mounted on top of a mixing console, within, for example, two meters of the engineer's sitting position so that the direct sound generated by the loudspeaker dominates over and above any reflected or ambient sound within the room.

It is well documented that speakers, when placed on top of a solid surface such as a desk, shelf, speaker-stand or mixing console, will couple with the mechanical structure and impart a sonic signature to the speakers. For instance, a shelf may resonate at 100 Hz (100 cycles per second) when a bass note is played by the loudspeaker. A 100 Hz peak will also be audible. One solution to this problem has been to isolate a loudspeaker from the mechanical structure by utilizing a soft urethane foam pad. Others have also presented options such as placing the loudspeaker on top of sand granules as a means to decouple the device and/or by suspending the speaker in the air with wires.

In all these cases, the loudspeaker is suspended to prevent the transfer of energy. But this in itself creates a new problem. The speaker is no longer stable. This problem may be understood by imagining the recoil generated by a rifle, when fired. The energy during the explosion forces the bullet out of the barrel while the rifle itself recoils back reducing the forward energy. If one were to fix the riffle so that the recoil would be eliminated, it would at once increase the forward energy but likely destroy the riffle after repeated use.

A loudspeaker is basically made of an electro-magnetic motor that drives a piston. As the speaker is energized with current, the piston moves to create sound. The sharper the transient wave, the more quickly and precisely the speaker should react. When the loudspeaker is suspended or placed on top of a ‘movable’ or ‘soft’ material, the forward momentum that would normally produce a distinct transient is softened (diminished) as the speaker recoils backwards. The result is a less distinct transient. This affects both low frequencies which produce bass and punch, and high frequencies which convey spatial information. Accordingly, there is a need for new apparatus, system and method for stabilizing a loudspeaker.

### SUMMARY

There is presented an apparatus, method and/or loudspeaker stabilizing system that isolates a loudspeaker from offensive tones caused by mechanical coupling while reducing the recoil that is introduced when the loudspeaker is suspended.

In one general aspect, an apparatus for stabilizing a speaker with respect to a surface comprises: an isolation portion to isolate the speaker from the surface; and a stabilizing portion provided between the speaker and the isolation portion to stabilize the speaker. The apparatus may further comprise a retaining portion provided between the speaker and the stabilizing portion to dampen the stabilizing portion. The apparatus may further comprise a resonance preventing portion to introduce impedance mismatch with respect to the stabilizing portion. The stabilizing portion may comprise multiple layers, platforms, or elements of different mass to prevent resonance. With respect to one or more of the portions, a hole, a change in mass, a change in size, and/or a change in shape may be provided to prevent resonance.

In another general aspect, an apparatus for stabilizing a speaker with respect to a surface comprises: an isolation portion which isolates the speaker from the surface to prevent the transfer of energy; and a stabilizing portion which requires more energy to set into motion, relative to that of the isolation portion, to reduce the recoil of the speaker and increase the momentum of sound produced by the speaker.

In yet another general aspect, a speaker system comprises: a speaker; and a speaker stabilizer for stabilizing the speaker with respect to a surface, comprising an isolation portion to isolate the speaker from the surface, and a stabilizing portion provided between the speaker and the isolation portion to stabilize the speaker. The speaker stabilizer may be provided to a base of the speaker. The mass of the speaker stabilizer may be different than that of the speaker to prevent resonance.

In still another general aspect, a method of stabilizing a speaker with respect to a surface comprises: providing an isolation portion to isolate the speaker from the surface; and providing a stabilizing portion between the speaker and the isolation portion to stabilize the speaker.

Other features will become apparent to those skilled in the art from the following detailed description, which, taken in conjunction with the attached drawing(s), discloses exemplary embodiments of the invention.

### BRIEF DESCRIPTION OF THE DRAWINGS

FIG. 1 is a diagram illustrating an exemplary speaker stabilizer for stabilizing a speaker.

Throughout the drawing and the detailed description, the same drawing reference numerals will be understood to refer to the same elements, features, and structures.

### DETAILED DESCRIPTION

The following detailed description is provided to assist the reader in gaining a comprehensive understanding of the apparatuses, methods and/or systems described herein. Accordingly, various changes, modifications, and equivalents of the apparatuses, systems and/or methods described herein will be suggested to those of ordinary skill in the art. Also, descriptions of well-known functions and constructions are omitted to increase clarity and conciseness.

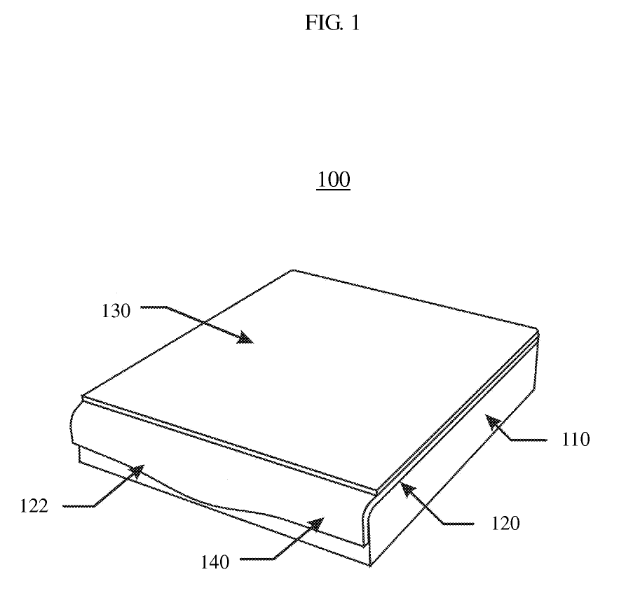

FIG. 1 is a diagram illustrating an exemplary speaker stabilizer 100 for stabilizing a speaker (not shown). As illustrated in FIG. 1, the speaker stabilizer 100 comprises: an isolation portion 110; a stabilizing platform portion 120; a retaining surface portion 130; and an impedance or resonance preventing portion 140.

The isolation portion 110 may act as, for example, a base medium. The isolation portion 110 may be any type of dampening material and may be produced in various shapes to meet the demands, and angled to direct the speaker (not shown) to the optimum listening position. In the example of FIG. 1, the isolation portion 110 mechanically isolates the speaker (not shown) and the stabilizing platform portion 120 from hard surfaces which in turn could resonate and introduce artifact into the sound field. In one implementation, the isolation portion 110 may be produced using a urethane foam but may also be produced using any type of soft, isolation or dampening material, spring or other insulating substance such as sand (granular). The isolation portion 110 may decouple the speaker from the hard surfaces such as a desk, shelf, or meter bridge to prevent resonance from the speaker transferring to, for example, the desk, and stops the resonant frequency of the desk from interfering with a musical playback of the speaker.

The stabilizing platform portion 120 provides mass to the speaker system to provide a stabilizing effect. The stabilizing platform portion 120 may be of any heavy rigid mass or any material whose weight will provide a stabilizing effect to the speaker system. In one implementation, the stabilizing platform portion 120 may be produced from steel, lead, concrete, granite, stone, or any other heavy material whose weight will sufficiently increase the overall mass of the speaker system. With the stabilizing platform portion 120, the speaker may better retain its physical position and is prevented from swaying or rocking when put on a soft medium such as foam. Where the speaker is stationary, the energy transfer to the speaker is forward and not lost due to the soft under-pad. This improves the transient response which in turn improves the bass performance, sonic detail, and dept of field. As shown in FIG. 1, a flange 122 may be provided to further increase the mass. The flange 122 may increase the weight while keeping the physical footprint smaller and/or used to control the ratio in mass of a speaker to speaker stabilizer 100 to a predetermined ratio. In the example of FIG. 1, the stabilizing platform portion 120 is dampened by sandwiching it between the isolation portion 110 and the retaining surface portion 130 as a means to reduce and prevent resonance or ringing. In further embodiments, this may be further augmented by introducing impedance changes in the medium such as changing the mass in various locations by, for example, cutting holes in the stabilizing platform portion 120, increasing the mass in certain areas and/or by altering the shape of the stabilizing platform portion 120.

The retaining surface portion 130 may serve to receive the speaker (not shown). In one embodiment, the retaining surface portion 130 may be used to hold the speaker in place and provide additional dampening of the stabilizing platform portion 120. The retaining surface portion 130 may be any form of applied surfacing material that may dampen the stabilizing plate portion 120 while providing added friction for the speaker. The retaining surface portion 130 and its thickness may be provided so as to provide a cushion for the speaker to prevent sliding around, while ensuring a positive coupling to the stabilizing platform portion 120.

The impedance or resonance preventing portion 140 may be provided to prevent resonance. In the example of FIG. 1, the flange 122 is also cut to an irregular shape to prevent the chance of the flange 122 vibrating or ringing at a specific frequency, and serves as the impedance or resonance preventing portion 140. The standing waves or resonance of the stabilizing platform portion 120 and the flange 122 is further reduced by providing an irregular shape or altering the size. In the example of FIG. 1, the occurrence of standing waves or resonance of the stabilizing platform portion 120 is dampened by the isolation portion 110 and the retaining surface portion 130. To further reduce the opportunity for vibration, the irregularly shaped front flange 122 is provided which adds an uneven mass to the stabilizing platform portion 120. This makes it difficult for a standing wave to exist as the inner vibrations cannot reach a stable or predictable resonating frequency. The front flange 122 is also dampened by the adjacent isolation portion 110.

While the construction of a speaker stabilizer has been shown to comprise three (or more) components, it will be understood that this is only an illustration of one of the many embodiments of the present invention. In one implementation, a speaker stabilizer may comprise three components or layers: an isolation component or layer; a stabilization platform component or layer; and a retaining surface component or layer. In another implementation, for example, additional isolation or stabilization may be achieved by adding additional component(s) or layer(s) to the speaker stabilizer design. For example, two different steel plates may be provided as a single assembly to form a stabilizing platform portion, or multiple layers of steel or other stabilizing mass may be used to introduce a greater degree of “impedance mismatch.” Even greater effect may be achieved by providing each plate, layer, or mass element of different weight (mass) as the energy will not sympathetically vibrate between them, that is, the vibration will be out of sync due to different resonant frequency.

Still yet in another implementation, a speaker stabilizer may comprise the use of an isolation medium with a stabilizing platform that in turn is coated with a non-slip surface. In another implementation, a speaker stabilizer may comprise a support and isolation structure. By increasing the mass of the stabilizing platform support and isolation structure, the speaker is presented with a stable platform that requires more energy to set into motion, relative to that of, for example, an isolation portion, while being isolated by the isolation portion of the structure.

Yet in another implementation, a predetermined mass relationship of, for example, a speaker stabilizer, a stabilizing platform portion of the stabilizer, a front flange of the stabilizer, and a speaker is provided to create an impedance mismatch or unpredictable set of mass variants that will prevent resonance. For example, a speaker stabilizer is provided to have a different mass than that of the speaker so that they will not vibrate in sympathy. As a further example, a speaker stabilizer may be provided such that a speaker to a speaker stabilizer ratio in mass of 4:1 is achieved, for example, providing a speaker stabilizer with 10 lbs in weight or more for a loudspeaker with 40 lbs in weight.

Furthermore, while the use of loudspeakers in recording industry is disclosed, it is understood that the present invention applies to the use of loudspeakers in all types of listening environments and applications including residential audio systems, commercial sound, and the like. It is understood that the term loudspeaker or speaker is used interchangeably and it may refer to, as an illustration, individual devices (or drivers), and complete systems consisting of an enclosure incorporating one or more drivers and additional electronics. It is also understood that the present invention may be produced in a variety of ways. As an illustrative embodiment, one or more components or layers of a speaker stabilizer may be laminated, or integrated in a structure such that, for example, a portion of the structure isolates a speaker while another portion stabilizes the speaker. Moreover, in a speaker system, a speaker stabilizer of the present invention may be applied to a loudspeaker itself, for example, introduced as a base of the loudspeaker.

According to certain embodiments described above, movement caused by the speaker, and the ensuing counter-effect, i.e., recoil, are significantly reduced. A given medium may resonate at one or more frequency based in its size, shape, mass and the energy that may excite it. By controlling the size, shape, mass, and form of a speaker stabilizer and its elements, as described above, the outcome is clearer more distinct and concentrated audio throughout the listening range.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for stabilizing a speaker with respect to a surface, comprising:
an isolation portion to isolate the speaker from the surface; and
a stabilizing portion provided between the speaker and the isolation portion to stabilize the speaker.

2. The apparatus of claim 1, wherein the stabilizing portion includes a non-slip surface to receive the speaker.

3. The apparatus of claim 1, wherein the stabilizing portion requires more energy to set into motion, relative to that of the isolation portion, to stabilize the speaker.

4. The apparatus of claim 1, further comprising a retaining portion provided between the speaker and the stabilizing portion to dampen the stabilizing portion.

5. The apparatus of claim 4, further comprising a resonance preventing portion to introduce impedance mismatch with respect to the stabilizing portion.

6. The apparatus of claim 5, wherein with respect to one or more of the portions of the apparatus, a hole, a change in mass, a change in size, and/or a change in shape is provided to prevent resonance.

7. The apparatus of claim 1, wherein the stabilizing portion comprises multiple layers, platforms, or elements of different mass to prevent resonance.

8. The apparatus of claim 1, wherein:
the isolation portion is a layer comprising any one of a urethane foam, spring, and sand granular; and
the stabilizing portion is a layer comprising any one of a steel, lead, concrete, granite, and stone.

9. An apparatus for stabilizing a speaker with respect to a surface, comprising:
an isolation portion which isolates the speaker from the surface to prevent the transfer of energy; and
a stabilizing portion which requires more energy to set into motion, relative to that of the isolation portion, to reduce the recoil of the speaker and increase the momentum of sound produced by the speaker.

10. The apparatus of claim 9, wherein with respect to one or more of the portions of the apparatus, a hole, a change in mass, a change in size, and/or a change in shape is provided to prevent resonance.

11. A speaker system comprising:
a speaker; and
a speaker stabilizer for stabilizing the speaker with respect to a surface, comprising:
an isolation portion to isolate the speaker from the surface, and
a stabilizing portion provided between the speaker and the isolation portion to stabilize the speaker.

12. The speaker system of claim 11, wherein the speaker stabilizer further comprises a retaining portion provided between the speaker and the stabilizing portion to dampen the stabilizing portion.

13. The speaker system of claim 11, wherein the stabilizing portion require more energy to set into motion, relative to that of the isolation portion, to stabilize the speaker.

14. The speaker system of claim 11, wherein with respect to one or more of the portions of the speaker stabilizer, a hole, a change in mass, a change in size, and/or a change in shape is provided to prevent resonance.

15. The speaker system of claim 11, wherein the speaker stabilizer is provided to a base of the speaker.

16. The speaker system of claim 11, wherein the mass of the speaker stabilizer is different than that of the speaker to prevent resonance.

17. The speaker system of claim 16, wherein a ratio of mass of the speaker and the speaker stabilizer is 4:1.

18. A method of stabilizing a speaker with respect to a surface, the method comprising:
providing an isolation portion to isolate the speaker from the surface; and
providing a stabilizing portion between the speaker and the isolation portion to stabilize the speaker.

19. The method of claim 18, further comprising providing a retaining portion between the speaker and the stabilizing portion to dampen the stabilizing portion.

20. The method of claim 18, wherein the providing of the stabilizing portion comprises providing the stabilizing portion requiring more energy to set into motion, relative to that of the isolation portion, to stabilize the speaker.

21. The method of claim 18, wherein the providing of the isolation and stabilizing portions comprise providing a hole, a change in mass, a change in size, and/or a change in shape with respect to one or more of the portions to prevent resonance.

22. The method of claim 18, further comprising providing a resonance preventing portion to introduce impedance mismatch with respect to the stabilizing portion.

23. The method of claim 18, wherein the stabilizing portion comprises multiple layers, platforms, or elements of different mass to prevent resonance.
